(19) United States
(12) Patent Application Publication
(10) Pub. No.: US 2014/0308127 A1
(43) Pub. Date: Oct. 16, 2014

(54) Airfoil blades with self-alignment mechanisms for cross-flow turbines

(71) Applicant: Calvin Chunliang Lee, Detroit, MI (US)

(72) Inventor: Calvin Chunliang Lee, Detroit, MI (US)

(21) Appl. No.: 13/986,184

(22) Filed: Apr. 10, 2013

(51) Int. Cl. F03D 7/04

(52) U.S. Cl. CPC F03D 7/04
USPC 416/44

(57) ABSTRACT

This invention proposes a cross-flow turbine design with airfoil blades and self-alignment mechanisms. The airfoil blade self-alignment mechanisms rotate the airfoil blades at half of the turbine main shaft's speed and dynamically flip the blades after reaching the windward position to realign the airfoil blades or reset the attack angle of each airfoil blade so that the airfoil blade feathers the fluid flow at the windward position, generates maximum drag force at or near the leeward position, and produces both maximum lift and drag forces in between.

### FIELD OF THE INVENTION

A turbine is a rotary mechanical device that extracts energy from a fluid flow, such as fluid flow, water, gas, or steam, and converts it into mechanical energy. The mechanical energy may drive machinery directly, such as a water pump or grinder, and is then called a wind or water mill. The mechanical energy may also be used to drive an electric generator to produce electricity, and is then called an electric power generator.

Turbines can be categorized into two types based on the relative orientation between the main rotating shaft and the fluid flow. A turbine with its main rotating shaft parallel to the fluid flow direction is called an axial-flow turbine. A turbine with the main rotating shaft perpendicular to the fluid flow direction is called a cross-flow turbine. This invention applies to a cross-flow turbine for improvement of fluid-to-mechanical energy conversion efficiency.

### BACKGROUND—DESCRIPTION OF PRIOR ART

A typical axial-flow turbine for wind energy application is often called a horizontal axis wind turbine (or HAWT), as shown in FIG. 1. It has a horizontal main rotational shaft attached to an electrical generator at the top of a tower. Axial-flow wind turbines used in wind farms for commercial production of electric power typically have three airfoil blades. The horizontal axis of the wind turbine is pointed into the wind by an electric actuator, such as a motor. Each airfoil blade has an airfoil shape that converts the fluid flow power to mechanical power via the lift force that turns the turbine, also shown in FIG. 1. The airfoil blades usually range in length from 20 to 60 meters for a commercial axial-flow wind turbine. The support towers may go up to 100 meters high. The airfoil blades rotate at 10-22 revolutions per minute. A gear box is commonly used to step up the speed of the shaft to better fit the operating speed range of the generator, though there are also designs that use direct drive of an annular generator.

Axial-flow turbines with well-designed airfoil blades of variable pitch have relative good efficiencies in converting the kinetic energy of the fluid flow passing through the airfoil blades to mechanical energy. Tall tower of an axial-flow wind turbine also allows access to stronger wind in higher altitude. In some sites, every ten meters up, the wind speed can increase by 20% and the power output by 34%. Note that the mechanical torque in the main rotational shaft is relatively constant. This is an advantage of an axial-flow turbine because it reduces stress on the bearings and related parts.

The major problem of the axial-flow turbines is most of the energy carrying fluid flow entering the swept area of the airfoil blades escapes through the huge gaps between the airfoil blades untapped. To capture this lost energy, the number of airfoil blades of an axial-flow turbine has to increase significantly from 3 in most cases to, say, an impractically expensive 30 or more, just like the design of a typical gas turbine. Therefore the overall fluid flow-to-mechanical energy generation capacity is far from being optimal.

Another disadvantage of the axial-flow turbines is the massive tower structure required to support the heavy and cantilevered assembly of the airfoil blades, main rotational shaft, gearbox, and generator. Those components are also difficult to install and maintain after installation.

A cross-flow turbine, which has the main rotational shaft attaching the airfoil blades to the generator oriented perpendicular to the fluid flow direction, sometimes is also called a vertical-axis wind turbine (VAWT) when applied to wind energy. Cross-flow turbines have the main rotational shafts positioned vertically to the ground in most cases. Based on the arrangement of the airfoil blades, there are two types of cross-flow turbines. A lift-type turbine with tangentially mounted airfoil blades is shown in FIG. 2a and a drag-type turbine with radially mounted airfoil blades is shown in FIG. 2b. A cross-flow turbine allows the generator and gearbox installed on or close to the ground so that a cross-flow turbine typically does not require a massive supporting tower structure. This leads to lower construction and maintenance costs as compared to an axial-flow turbine of similar capacity. Another key advantage is the turbine airfoil blades don't need to be pointed into the fluid flow, saving a yaw control mechanism. This is an advantage on sites where the wind direction is highly variable.

Conventional cross-flow turbines are not as effective as axial-flow turbines in power generation. For a drag-type cross-flow turbine, the torque is only generated by the airfoil blades when they are at or near the “leeward” position (i.e. where the airfoil blade moves in the same direction as the fluid flow), as shown in FIG. 2b. The airfoil blades actually work against the turbine when they are at or near the “windward” position (i.e. where the airfoil blade moves against the fluid flow) because they actually generate negative torque. For a lift-type cross-flow turbine, the airfoil blades generate torque between leeward and windward positions. At or near leeward and windward positions, the lift force doesn't generate any useful torque at all; therefore it is also not very effective in converting the kinetic energy in the fluid flow to mechanical energy. However, a cross-flow turbine has a much higher percentage of fluid flow run across the airfoil blades, leaving potential of improving the overall energy generation capacity if the airfoil blades can be oriented in a favorable way.

There are many US patents propose to manipulate the orientations of the airfoil blades of the cross-flow turbines. U.S. Pat. No. 1,352,859, which is a drag-type cross-flow turbine, uses a complicated gear mechanism to control the attack angle between each of the airfoil blades and the fluid flow. The airfoil blades always “feather” the fluid flow (i.e. keeping the airfoil blade paralll to fluid flow) when they are at or near windward position to minimize the negative torque. The gear mechanism also helps to align the airfoil blades to be perpendicular to the fluid flow when they are at or near leeward position to maximize the positive drag force to help turning the turbine. However, this invention doesn't use airfoil airfoil blades to generate additional lift force in addition to drag force to further improve the energy conversion efficiency of the turbine.

U.S. Pat. No. 7,385,302 has a circular rotatable frame that rotates around the main rotational shaft of a cross-flow turbine. Each airfoil blade is installed on a pivotal shaft which is assembled to the circular frame. A stationary circular guide in the shape of half-circle is used to turn the pivotal shafts of the Airfoil blades to allow the airfoil blades feather the fluid flow at or near the windward position. The circular rotatable frame, the stationary circular guide, and the rollers, which allow the frame to rotate around an axis, add complexity and manufacturing cost of the turbine. The hard contacts between the rollers and the circular rotatable frame and the hard contacts between the pivotal shafts and the circular guide increase frictional loss and may require frequent maintenance. This design doesn't consider the aerodynamic lift to further improve the energy conversion efficiency, either. This design may also run into trouble in handling the situation when the fluid flow changes direction.

U.S. Pat. No. 6,926,491 proposes another drag-type cross-flow turbine. Each airfoil blade pivots by the fluid flow to feather the fluid flow at or near the windward position and is constrained by two stops to limit the airfoil blade's movement at or near the leeward position to generate positive torque. This design is simple and is better than the conventional cross-flow turbines, but it doesn't take advantage of the aerodynamic lift force and therefore its overall energy generation capacity is not maximized. U.S. Pat. No. 7,083,382 proposed a design similar to U.S. Pat. No. 6,926,491 that has the same benefits and shortcoming.

U.S. Pat. No. 4,979,871 proposes an improved cross-flow turbine with a control mechanism to change the angle of attack of each airfoil blade for better efficiency. It uses a sprocket-chain or gear mechanism to rotate each airfoil blade around its individual pivotal shaft at half of the speed of the main rotating shaft of the turbine itself. Because the airfoil blade rotates only half of a turn when the turbine completes a full turn of rotation, the airfoil blade itself has a symmetric cross section with respect to its chord. This constraint reduces the efficiency of the turbine because a airfoil blade with symmetric cross section does not generate much aerodynamic lift force. If the airfoil blades have nonsymmetrical geometry to generate maximum lift force during one cycle, the airfoil blades may generate negative lift force in the subsequent cycle because the airfoil blade is now turned upside down.

U.S. Pat. No. 4,764,090 uses a weather vane activated rack-and-pinion mechanism to adjust the angle of attack of each airfoil blade according to the fluid flow speed to reduce the aerodynamic drag at or near the windward position. It also controls the attack angles of the upper and lower ends of each vertical airfoil blade independently. However, this invention doesn't orient the airfoil blades with 90° attack angle at or near the leeward position to take advantage of the maximum aerodynamic drag force. This invention also requires a complicated mechanism that may have high initial and maintenance costs.

U.S. Pat. No. 4,430,044 uses the balance between the centrifugal force of a lever mechanism and the aerodynamic force generated on each airfoil blade from the fluid flow to control the attack angle of the airfoil blade at different airfoil blade positions and turbine speeds. At lower turbine speed, the airfoil blades are controlled to have higher attack angles at or near the windward position. This invention does not allow the airfoil blades to generate the most positive torque at or near the leeward position by maximizing the aerodynamic drag, either.

U.S. Pat. No. 4,383,801 uses an eccentrically mounted flange to align the airfoil blades so the aerodynamic lift force generated by each airfoil blade is always in favor of turning the fluid flow turbine while the aerodynamic drag is minimized at or near both the windward and leeward positions. This patent is basically a lift-type turbine and misses the opportunity of harvesting more fluid flow energy via aerodynamic drag force.

U.S. Pat. No. 5,676,524 is another lift-type cross-flow turbine that has a similar working principle as U.S. Pat. No. 4,383,801. It uses an eccentric mechanism to align the airfoil blades so the aerodynamic drag is minimized and the aerodynamic lift on each airfoil blade is always in favor of turning the turbine.

U.S. Pat. No. 4,052,134 has each pivotal airfoil blade that is adjusted by an eccentric mechanism to maintain relatively constant attack angles (e.g. +/−10° with respect to the relative velocity of the airfoil blade in different positions during the turning of the turbine. However, the resulting aerodynamic forces generated by each airfoil blade in different positions may not always help to turn the fluid flow turbine. The eccentric mechanism is also very complicated that may have high initial and maintenance costs.

A design, called “sail turbine”, published on a website (http://sailturbine.envy.nu/) illustrates a design of a combination of the lift- and drag-type cross-flow turbines. It has a mechanism that links the airfoil blades to the main rotating shaft to regulate the spinning speed of the airfoil blades to be half of the main rotating shaft to practically minimize the negative drag torque at or near the windward position while maximizing the positive drag torque at or near the leeward position.

It also uses flexible “sails” as the airfoil blades, claiming the resulting aerodynamic force on the sail airfoil blade will naturally bend each sail airfoil blade to form an airfoil that will then maximize the positive torque. However, this design is impractical because the fluid flow around a bent sail airfoil blade is negligible when compared to a real airfoil in generating the aerodynamic lift force.

### OBJECTS AND ADVANTAGES

A conventional axial-flow turbine usually doesn't harvest much fluid flow energy because its airfoil blades only “harvest” energy from a small percentage of the fluid flow that flows through its swept area. A cross-flow turbine's airfoil blades usually “intercept” more fluid flow. However, a conventional cross-flow turbine usually has a lower efficiency because its airfoil blades don't always generate much,positive torque to turn the turbine. This adverse effect is usually demonstrated by a higher minimum fluid flow speed to start a conventional cross-flow fluid flow turbine needs to start a conventional fluid flow turbine.

Most prior inventions mentioned above don't consider the relative velocity of each airfoil blade with respect to the fluid flow after the turbine gains speed. In general the higher the turbine speed, the less positive torque generated by the airfoil blades due to adverse change of the attack angles of the airfoil blades. At certain turbine speed, the negative torque equals the positive torque and the turbine reaches its maximum operational speed. This rule of thumb applies to both axial and cross-flow fluid flow turbines.

An ideal turbine should have airfoil blades that interact with 100% of the fluid flow entering its swept area and operates efficiently at both low and high fluid flow speeds. The proposed cross-flow turbine has blades of simpler design but with larger blade area interacting with more of the fluid flow entering the turbine's swept area. It practically eliminates the significant negative torque of a conventional cross-flow turbine with radial-mounted airfoil blades at or near the windward position, as shown in FIG. 2b, while maximizing the drag force at leeward position at low to medium turbine speeds. Its airfoil blade alignment mechanisms adjust each airfoil blade's attack angle to produce better positive torque at low to high turbine and fluid flow speeds than a conventional cross-flow turbine with tangentially mounted airfoil blades.

The overall operation of the proposed cross-flow turbine costs less, is easier for maintenance, and is more efficient in energy generation in low and high turbine and fluid flow speeds.

### SUMMARY OF THE INVENTION

This invention covers a cross-flow turbine design with airfoil blades and airfoil blade alignment mechanisms. The airfoil blade alignment mechanisms dynamically adjust the attack angle of each airfoil blade so that the airfoil blade align itself to feathers the fluid flow at or near the windward position and generates maximum aerodynamic drag force at or near the leeward position. The airfoil blade alignment mechanisms also flip or transform the airfoil blades at or near the windward position to allow usage of asymmetric airfoil geometry for the airfoil blades. When turbine speed increases, the effective attack angle of the airfoil blade decreases and eventually becomes 0° or 180° when turbine speed equal to fluid flow speed. However, the airfoil blades still generate positive torque so the turbine speed will keep increasing until the net torque decreases to zero.

### BRIEF DESCRIPTION OF DRAWING FIGURES

FIG. 1 shows a conventional axial-flow turbine.

FIGS. 2a and 2b show typical cross-flow turbines with tangential-mounted and radial-mounted airfoil blades, respectively.

FIG. 3a shows the orientations of an individual airfoil blade in different rotational positions A, B, C, D, E, F, G, and H of an ideal cross-flow turbine and the corresponding aerodynamic forces at zero turbine speed.

FIG. 3b shows the orientations of an individual airfoil blade in different rotational positions A, B, C, D, E, F, G, and H of an ideal cross-flow turbine and the corresponding aerodynamic forces at medium turbine speed.

FIG. 3c shows the orientations of an individual airfoil blade in different rotational positions A, B, C, D, E, F, G, and H of an ideal cross-flow turbine and the corresponding aerodynamic forces at high turbine speed.

FIG. 4 shows a macroscopic view of the proposed cross-flow turbine with the airfoil blades and airfoil blade alignment mechanisms that drives an electric generator.

FIG. 5 shows the top view of the first preferred embodiment of the proposed cross-flow fluid flow turbine with three airfoil blades and corresponding electronically controlled airfoil blade-alignment mechanisms.

FIG. 6a shows the detail views of one of the airfoil blades and its electronically controlled airfoil blade-alignment mechanism at the windward position of the first preferred embodiment of the proposed cross-flow fluid flow turbine.

FIG. 6b shows the detail design of the quick strike mechanism and the airfoil blade cycler of the first preferred embodiment.

FIGS. 7a to 7f illustrate the operation of the turbine and its airfoil blade alignment mechanism.

FIG. 8a shows the detail views of the second preferred embodiment with an airfoil blade and its mechanical airfoil blade alignment mechanism at the windward position.

FIG. 8b shows the detail design of the quick strike mechanism and the airfoil blade cycler of the second preferred embodiment.

FIG. 8c shows the detail design of the quick strike mechanism and the airfoil blade cycler of the second preferred embodiment.

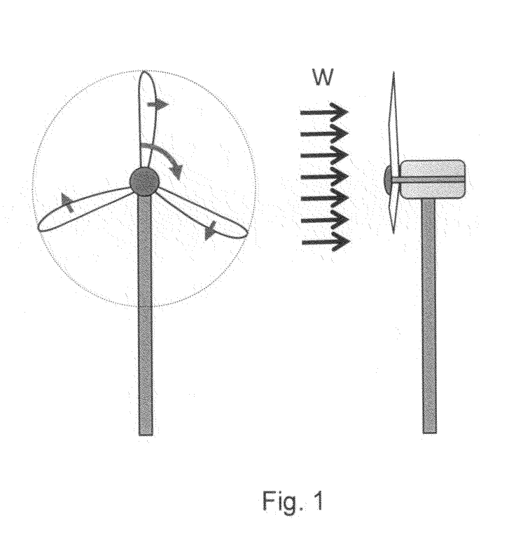

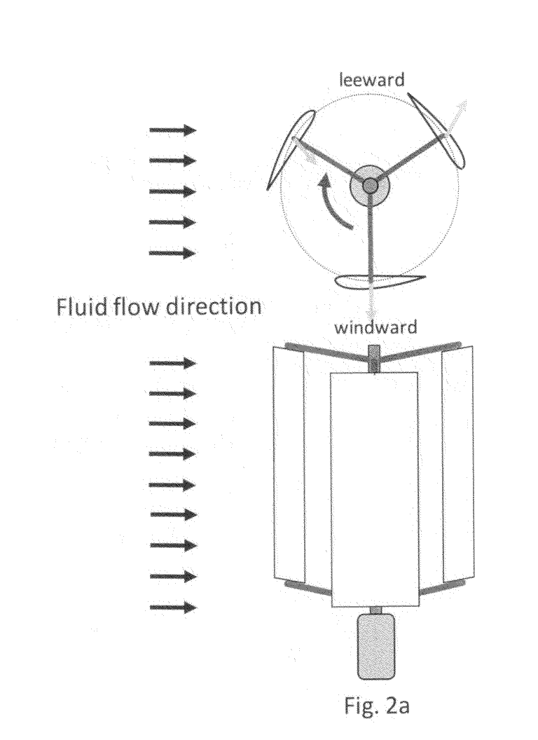

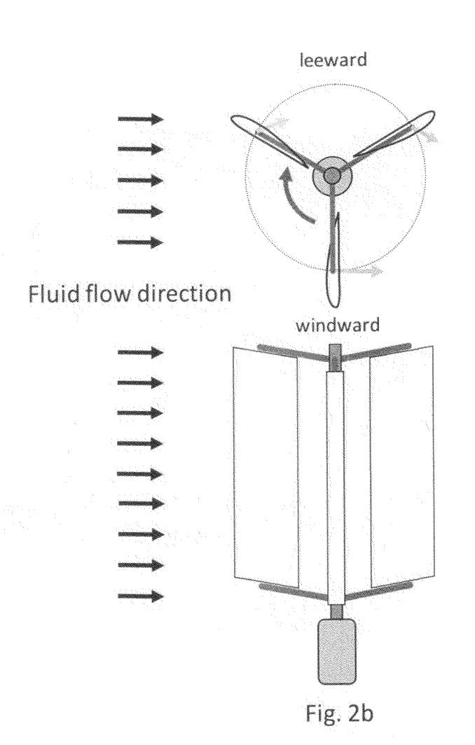

### REFERENCE NUMERALS IN DRAWINGS

1. Main rotational shaft
2. Airfoil blades
3. Radial support arms
4. Airfoil blade alignment mechanisms
5. Stationary support structure
6. Electric generator
7. Gearing from main rotational shaft to electric generator
11. Fluid flow absolute velocity
12. Relative velocity of the fluid flow with respect to the airfoil blade
13. Aerodynamic force
14. Airfoil blade linear velocity due to turbine rotation
15. Turbine rotational velocity
31. Timing belt/chain
32. One-way bearing
33. Airfoil blade shaft bearing
34. Airfoil blade drive gear
35. Shaft pulley/sprocket
36. Airfoil blade shaft
37. Torsional spring
38. Quick strike mechanism
39. Striker
40. One-way bearing
41. Airfoil blade drive pulley/sprocket
42. Airfoil blade cycler
43. Spring stop
44. Spring holder
45. Radial support arm position sensor
46. Airfoil blade drive actuator
47. Electronic control module
48. Fluid flow direction sensor
49. Solenoid
50. Solenoid shaft
51. Vertical extension of quick strike mechanism
52. Horizontal extension of airfoil blade cycler
53. Airfoil blade cycler retainer
54. Electric wirings from electronic control module to solenoids
55. Electric wirings from electronic control module to airfoil blade drive actuator
56. Electric wiring from electronic control module to radial support arm position sensor
57. Electric wiring from electronic control module to fluid flow direction sensor
58. Turbine orientation actuator
59. Turbine shaft
60. Turbine orientation gearing
61. Horizontal extension of quick strike mechanism
62. Quick strike mechanism shaft

### DETAILED DESCRIPTION OF THE PREFERRED EMBODIMENTS:

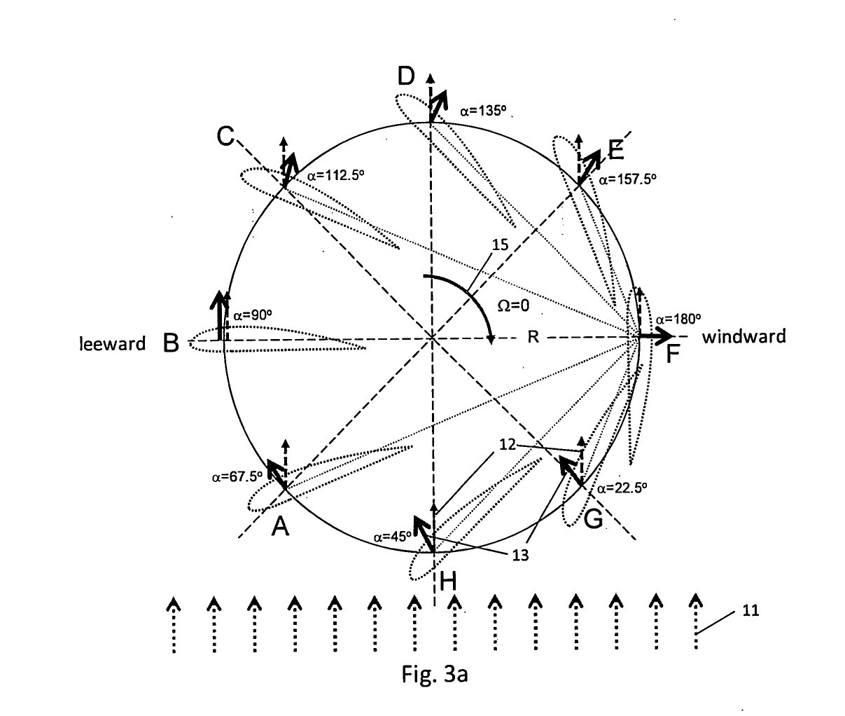

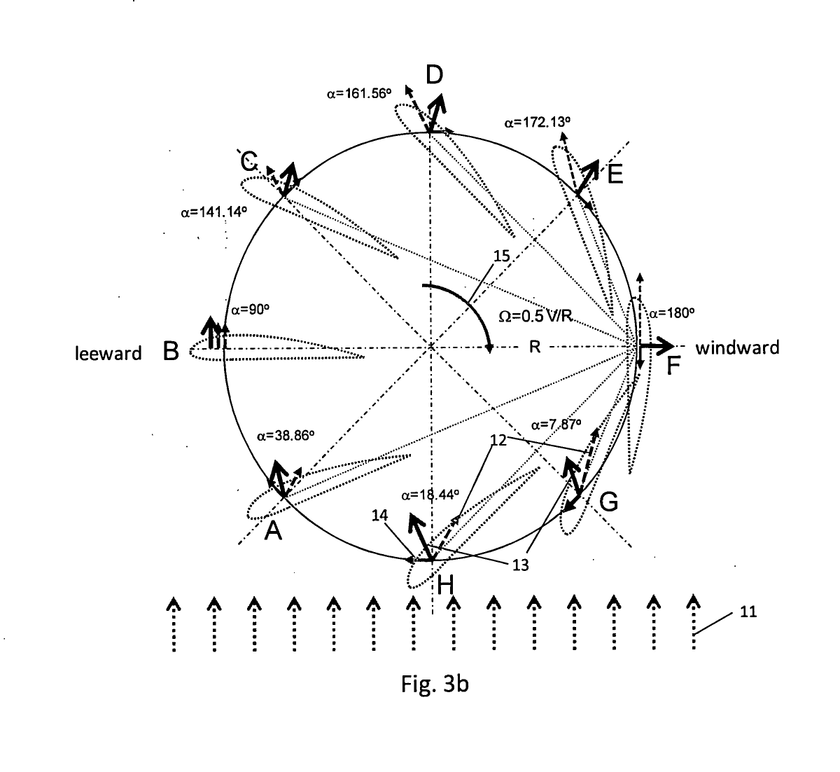

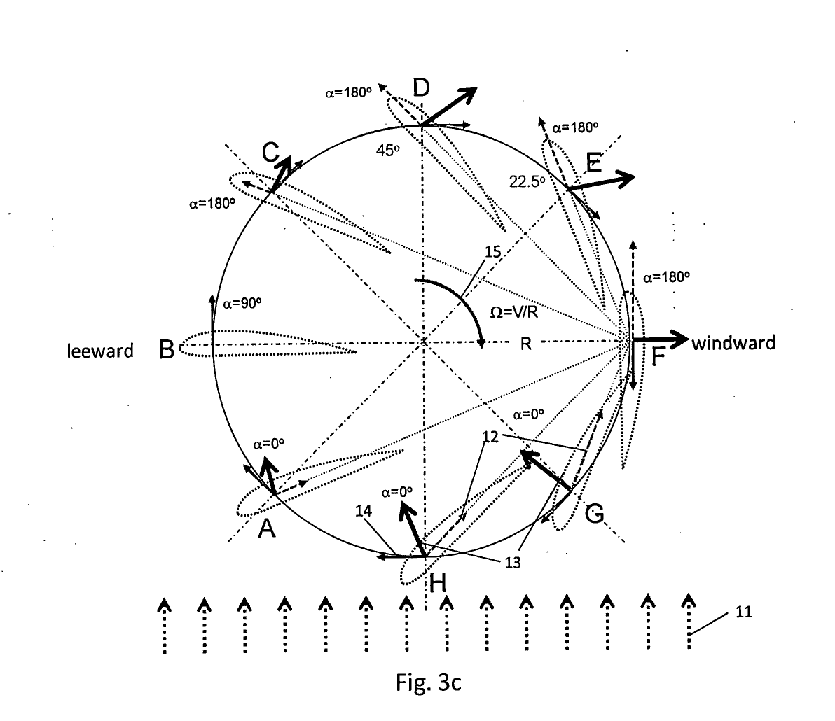

An ideal turbine has airfoil blades that interact with 100% of the fluid flow entering the turbine's swept area and operates at maximum efficiency at both low and high fluid flow speeds. This proposed design align each airfoil airfoil blade so that it rotates at a constant speed of half of the turbine itself, feathers the fluid flow (with an attack angle of 180°) at windward position, turns quickly by 180° (with an attack angle of 0°) right around the windward position, and maximizes the drag force at leeward position (with an attack angle of 90°). FIGS. 3a, 3b, and 3c show the top views of an airfoil blade at different rotational positions A, B, C, D, E, F, G, and H of an ideal cross-flow turbine at different turbine speeds.

When the turbine starts to turn from standstill, the relative velocity of the fluid flow with respect to the airfoil blade 12 is the same as the fluid flow velocity 11, as shown in FIG. 3a, since the airfoil blade's velocity 14 is zero. The aerodynamic forces 13 generated by the airfoil blades at different positions are also shown in FIG. 3a. The maximum aerodynamic force 13 happens at leeward position and produces the maximum torque. At windward position, the aerodynamic force 13 is perpendicular to the rotation and therefore it produces zero torque. There is no negative torque produced at all, unlike the traditional drag-type cross flow turbines.

When the turbine picks up speed, the relative velocity of the fluid flow with respect to the airfoil blade 12 starts to deviate from the fluid flow velocity 11. FIG. 3b shows the situation when the turbine runs at a speed that is half of the fluid flow speed, i.e. RΩ=½ V, where R is the length of the radius of the turbine, Ω is the rotational speed of the turbine, and V is the fluid flow speed. The most significant change is the aerodynamic force 13 at leeward is reduced by half. The aerodynamic forces 13 at different positions vary—some increase and some decrease. The resulting net torque increases from the startup condition and there is no negative torque produced at any position.

FIG. 3c shows the situation when the turbine speed is the same as the fluid flow speed, i.e. RΩ=V. The relative velocity of the fluid flow with respect to the airfoil blade 12 at leeward position is now zero, causing the aerodynamic force 13 to drop to zero. The resulting net torque still increases and there is still no negative torque produced at any position up to this point. If the turbine speed keeps increasing, the aerodynamic force 13 at leeward will start to around and produce a negative torque. The resulting net torque will start to decrease before turn to negative.

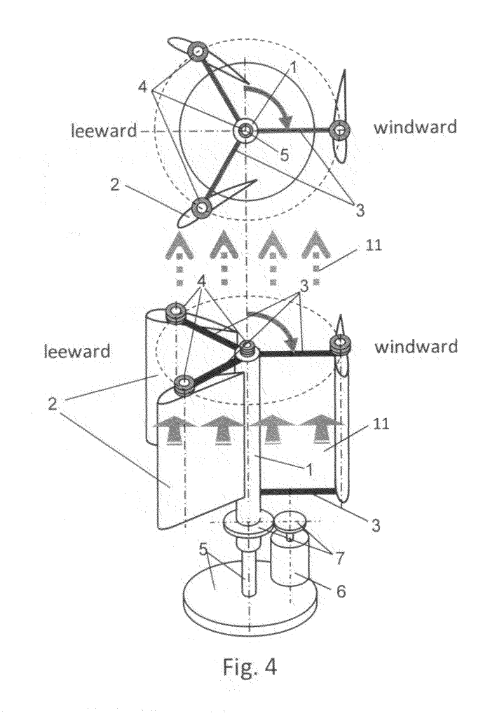

The proposed cross-flow turbine, as shown in FIG. 4, consists of a main shaft 1, a number of airfoil blades 2 with airfoil blade alignment mechanisms 4, a set of radial support arms 3 that connect the airfoil blades to the main shaft, and a stationary support structure 5. Each airfoil blade 2 is rotationally connected to one end of a radial support arm 3. The radial support arms 3 are radially aligned and rigidly attached to the main shaft 1 at the other end. The main shaft 1 is then rotationally installed to a stationary support structure 5, which is fixed to the ground or a stable structure. The main shaft 1 of the cross-flow turbine drives an electric generator 6 to generate electricity.

Each airfoil blade alignment mechanism 4 is installed between an airfoil blade 2 and the radial support arms 3 and controls the relative rotational movement of the airfoil blade 2 with respect to the radial support arms 3. It aligns the airfoil blades with respect to the fluid flow velocity 11, also as shown in FIGS. 3a, 3b, and 3c, to maximize the aerodynamic force each airfoil blade can generate.

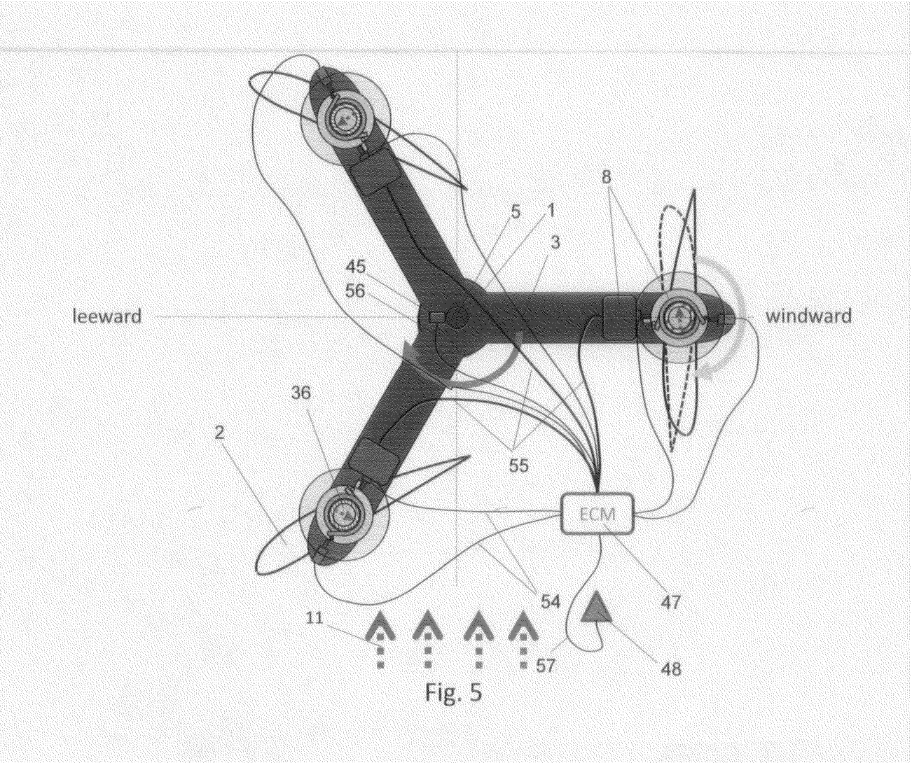

The first preferred embodiment of this invention is shown as a top view in FIG. 5 with a main shaft 1, three airfoil blades 2 and radial support arms 3, an electronic control module 37 that controls the self-alignment mechanisms 4 to adjust the airfoil blade orientations to take advantage of the combined lift and drag forces harvested from the fluid flow. The turbine's main shaft turns in clockwise direction. Each airfoil blade also turns around its shaft 36 clockwise when the main shaft turns. The key activity that allows the combined lift and drag operation is that when a airfoil blade 2 reaches the windward position, it needs to make a quick 180° rotation around its shaft 36 to realign itself for the next cycle.

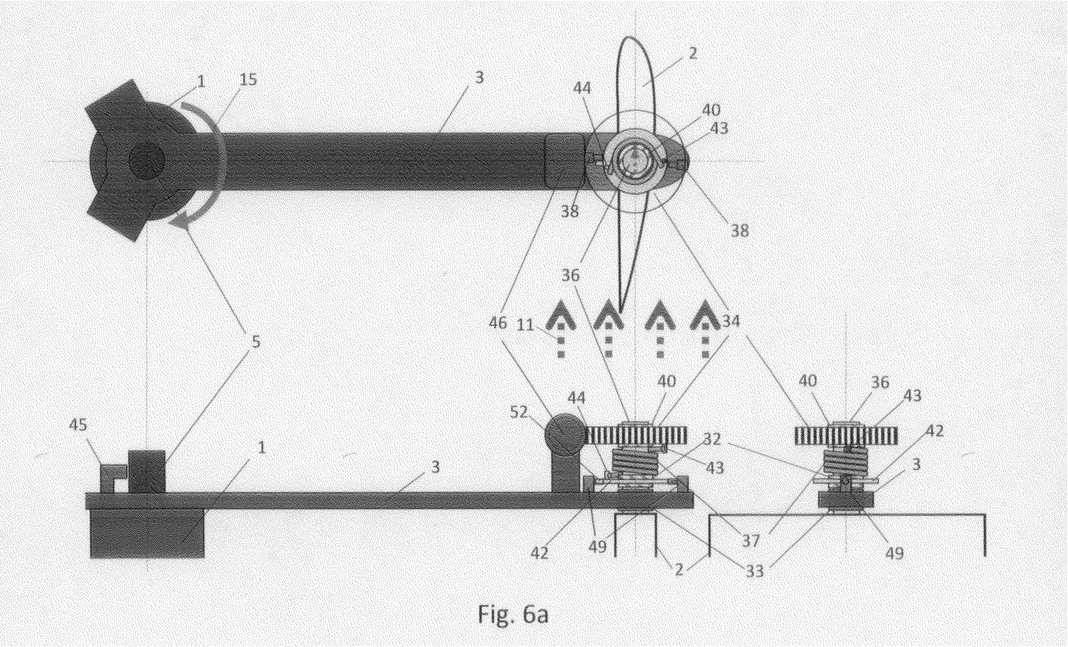

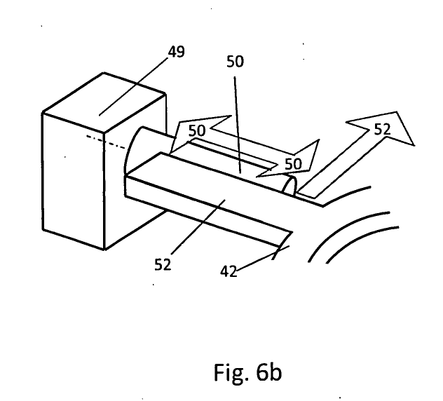

FIG. 6a shows the detail design of the first preferred embodiment in three views. A main shaft 1 rotates about the stationary support structure 5. A radial support arm 3 is rigidly connected to the main shaft 1. An airfoil blade shaft 36 is rotationally installed to the radial support arm 3 via an airfoil blade shaft bearing 33. An airfoil blade 2 is rigidly connected to the airfoil blade shaft 36. An airfoil blade drive gear 34 is installed to the airfoil blade shaft 36 via a one-way bearing 40 and is driven by an airfoil blade drive actuator 46 through gear mesh. The one-way bearing 40 lets the airfoil blade drive gear to engage and drive the airfoil blade shaft 36 in one direction (i.e. clockwise in the configuration shown in the top view of FIG. 6a) while allowing the airfoil blade shaft 36 to freewheel (i.e. run free from the airfoil blade drive gear 34) when the airfoil blade shaft 36 runs faster than the airfoil blade shaft gear 34 in clockwise direction.

The airfoil blade drive actuator 46 is controlled by an electronic control module 47 (as shown in FIG. 5) with input from a radial support arm position sensor 45 and a fluid flow direction sensor 48. An airfoil blade cycler 42 is rotationally installed to the airfoil blade shaft 36 via a second one-way bearing 32. The one-way bearing 32 lets the airfoil blade cycler 42 to engage and drive the airfoil blade shaft 36 in one direction (i.e. clockwise in the configuration shown in the top view of FIG. 6a) while allowing the airfoil blade shaft 36 to freewheel (i.e. run free from the airfoil blade cycler 42) when the airfoil blade shaft 36 runs faster than the airfoil blade cycler 42 in clockwise direction. A torsional spring 37 has a spring stop 43, which is rigidly attached to the airfoil blade drive gear 47, and a spring holder 44, which is rigidly installed to the airfoil blade cycler 42.

A horizontal extension of airfoil blade cycler 52, an integral part of the airfoil blade cycler 42 as shown in FIGS. 6a and 6b, is at the same height as the shaft 50 of a solenoid 49, as a preferred embodiment of the quick strike mechanism 38, when measured from the radial support arm 3. When the solenoid 49 is deactivated, its shaft 50 is in the extended position so that it effectively stops the horizontal extension of the airfoil blade cycler 52 and prevents the airfoil blade cycler 42 from rotating.

When the airfoil blade drive actuator 46 drives the airfoil blade drive gear 34, it turns the airfoil blade shaft 36 clockwise, as shown in FIG. 6a. The spring stop 43 turns with the airfoil blade drive gear 34 and compresses\the torsional spring 37 since the solenoid shaft 50 prevents the spring holder 44, which holds the other end of the torsional spring 37 and is rigidly installed to the airfoil blade cycler 42, from turning. The torsional spring 37 will increase its potential energy when the airfoil blade drive gear 34 and airfoil blade shaft 36 continues to turn until the electronic control module 47 sends a signal to activate the solenoid 49 to retract the solenoid shaft 50 and allows the airfoil blade cycler 42 to turn after the release of the horizontal extension of airfoil blade cycler 52.

The airfoil blade cycler 42′s rotation is powered by the release of the stored energy in the torsional spring 37. When the airfoil blade cycler 42 turns, the one-way bearing 32 engages the airfoil blade cycler 42 and the airfoil blade shaft 36 so they turn together. This effectively rotates the airfoil blade 2, which is rigidly connected to the airfoil blade shaft 36, until the horizontal extension of airfoil blade cycler 52 is stopped by a second solenoid 49 that is 180° apart from the original solenoid to complete a full 360° cycle of a airfoil blade of the turbine.

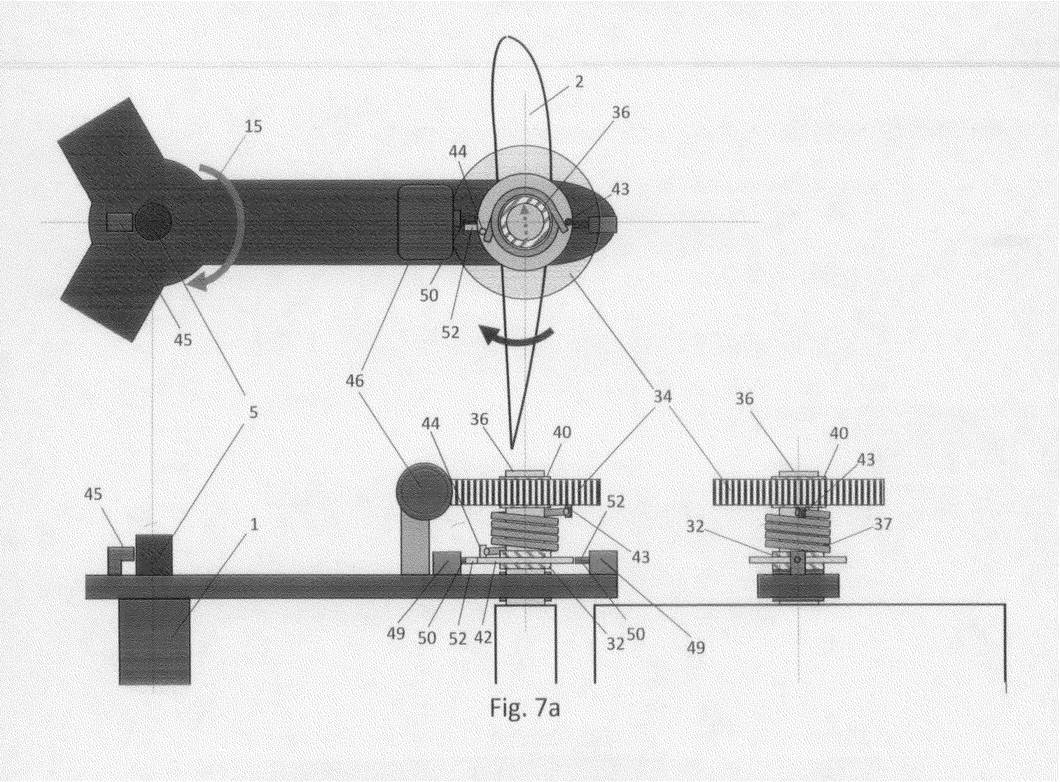

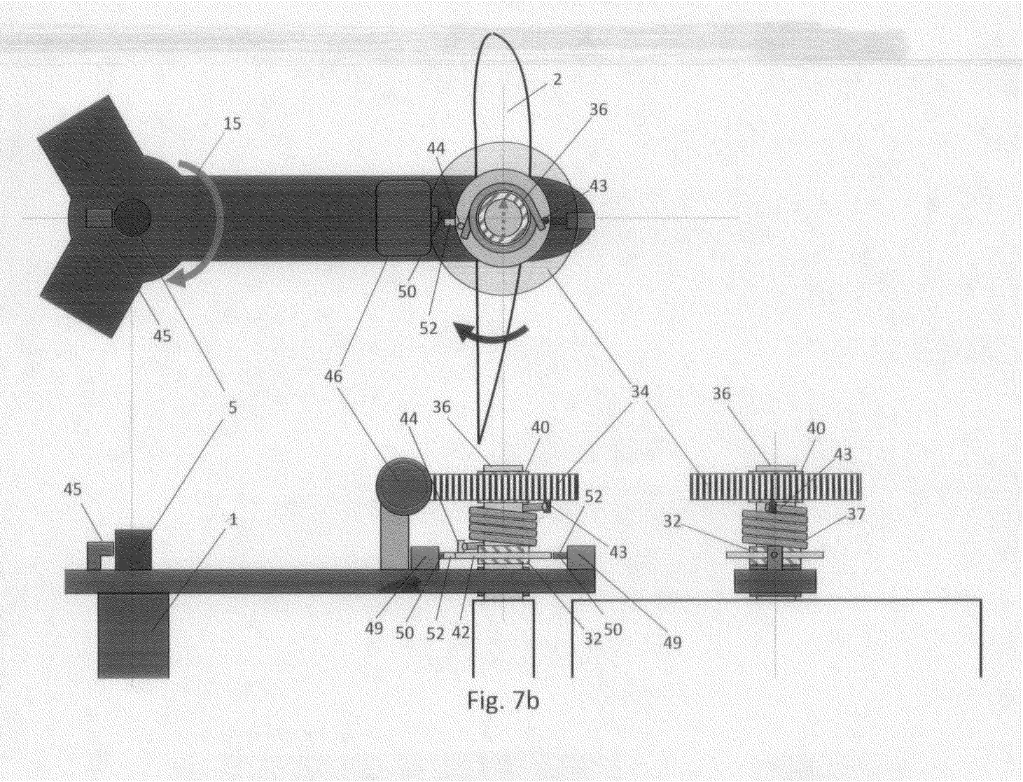

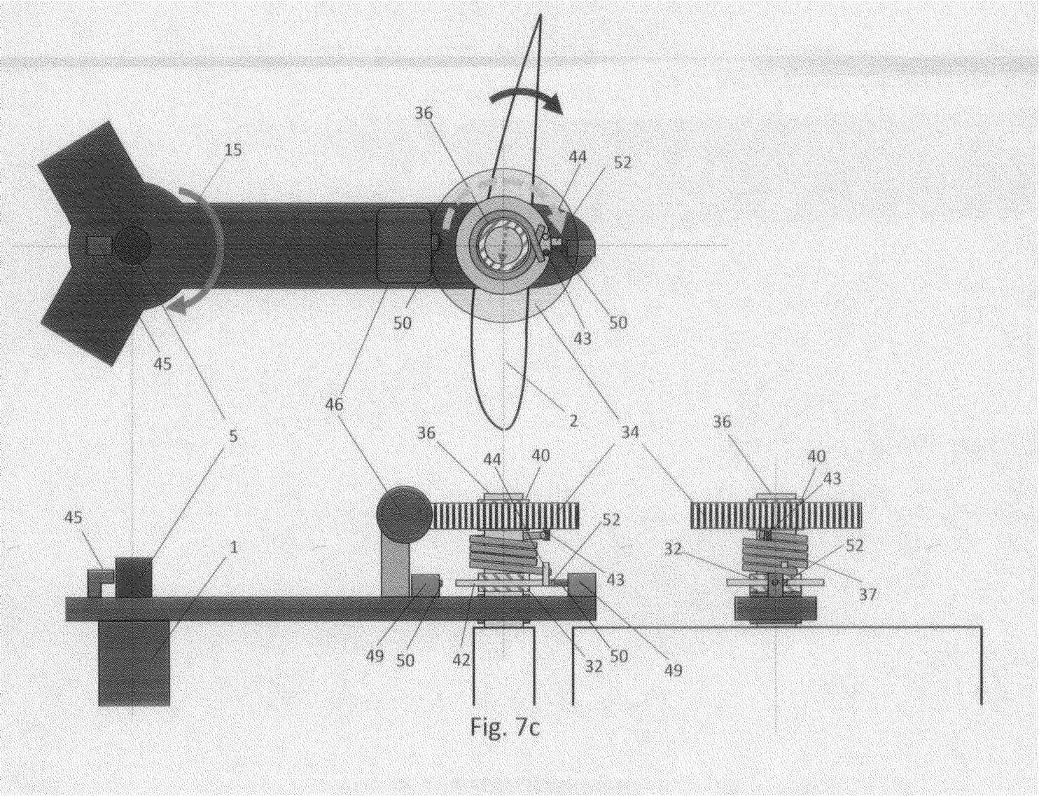

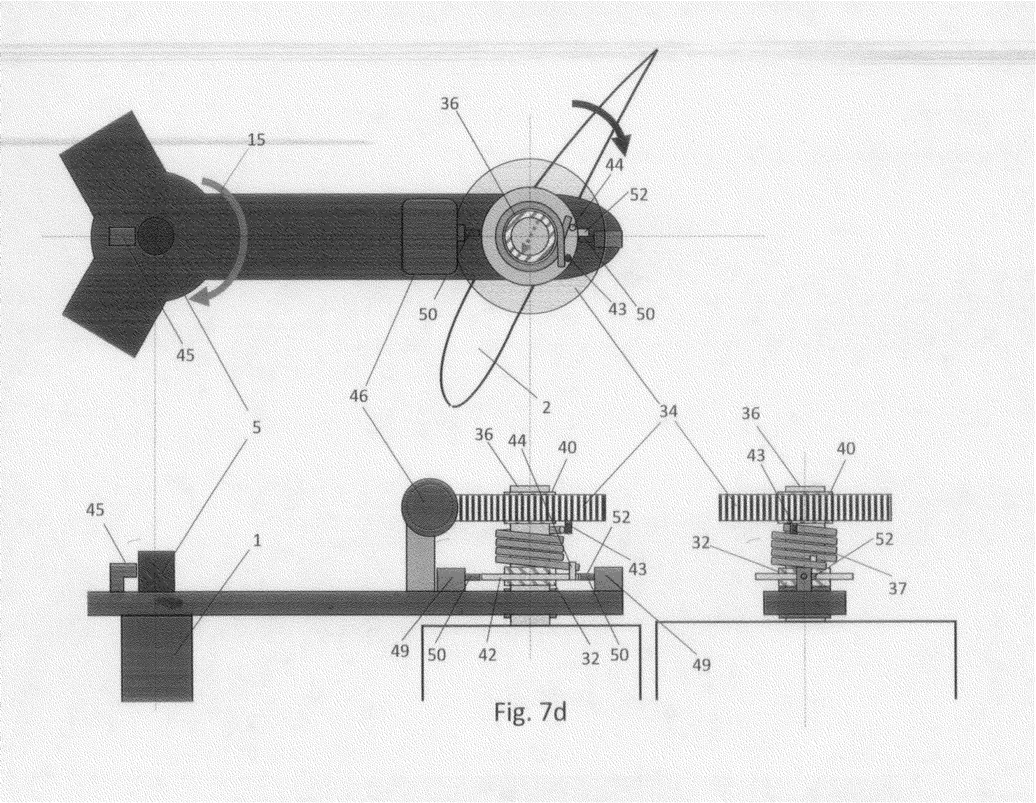

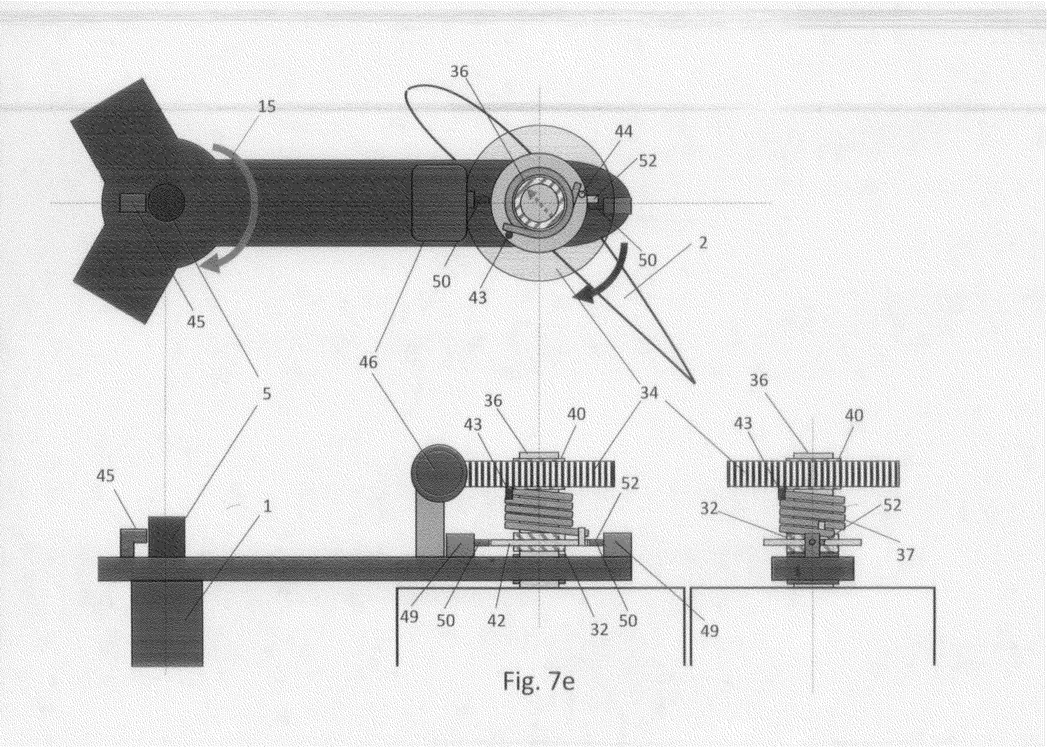

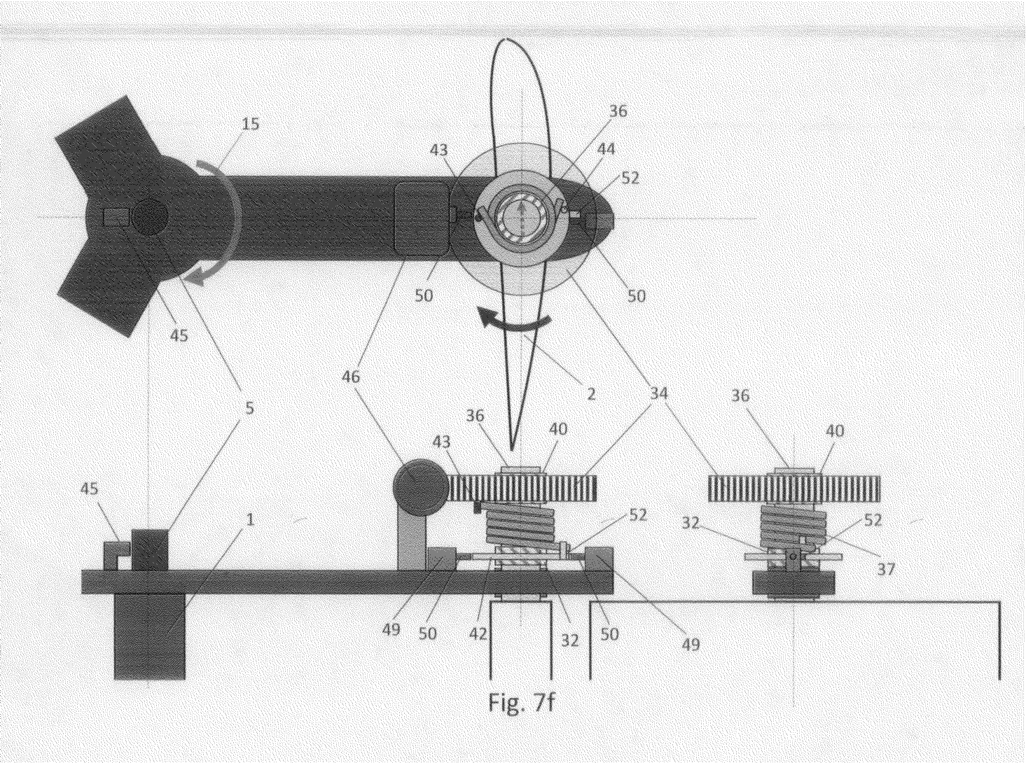

FIGS. 7a-7f show the operation of a complete 360° cycle of one of the airfoil blades of the first preferred embodiment of the turbine with self-alignment mechanism. FIG. 7a shows the airfoil blade 2 instantaneous before it reaches the windward position. At this position, the airfoil blade 2 is perpendicular to the radial support arm 3 and feathers the fluid flow with tail as the leading edge. The horizontal extension of airfoil blade cycler 52 engages the solenoid shaft 50, as shown in FIG. 7a, while the rotation of the airfoil blade shaft 36, driven by the airfoil blade drive actuator 46, compresses the torsional spring 37 to store up potential energy.

FIG. 7b shows the airfoil blade 2 at the windward position. The electronic control module 47, as shown in FIG. 5, receives and processes a signal from the radial support arm position sensor 45 and sends a command to activate the solenoid 49 to start to retract the solenoid shaft 50. FIG. 7c shows the airfoil blade 2 shortly after the windward position. The solenoid shaft 50 has retracted fully to allow the airfoil blade cycler 42 to freely rotate clockwise by disengaging the horizontal extension of airfoil blade cycler 52 with the torsional spring 37 releasing its potential energy to drive the airfoil blade cycler 42. The airfoil blade cycler 42 turns the airfoil blade shaft 36 and then the airfoil blade 2 itself by 180° before the horizontal extension of airfoil blade cycler 52 is stopped by the secolad solenoid shaft 50 on the opposite side.

FIG. 7d shows the airfoil blade 2 at 30° after windward position. The airfoil blade cycler 42 is engaged with the solenoid shaft 50 and the airfoil blade drive actuator 46 continues to drive the airfoil blade drive gear 34 to turn the airfoil blade 2 and also compress the torsion spring 37. FIG. 7e shows the continuation of the operation to 135° after windward position. The airfoil blade 2 continues to turn clockwise and the torsional spring 37 is increasingly compressed by the airfoil blade drive actuator 46.

FIG. 7f shows the airfoil blade 2 right before it reaches windward position the second time, just like the condition shown in FIG. 7a except the solenoid shaft 50 that stops the horizontal extension of airfoil blade cycler 52 is on the opposite side of the airfoil blade shaft 36. The solenoid 49 will then be activated by the electronic control module 47 to retract the solenoid shaft 50 to allow the airfoil blade cycler 42 to quickly turn the airfoil blade 2 by 180° when it reaches windward position, just as shown in FIG. 7a.

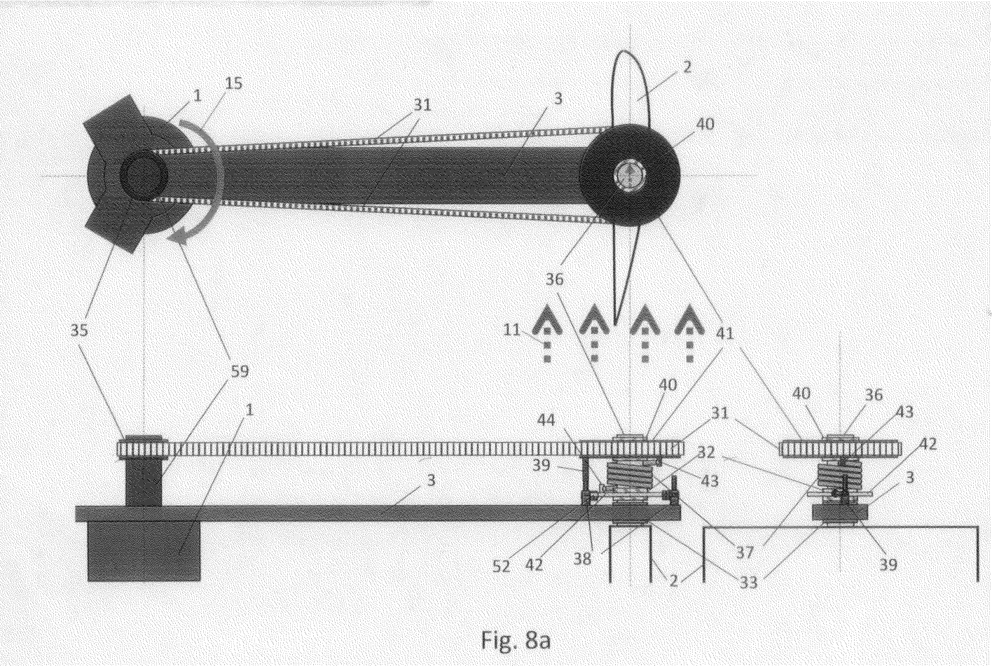

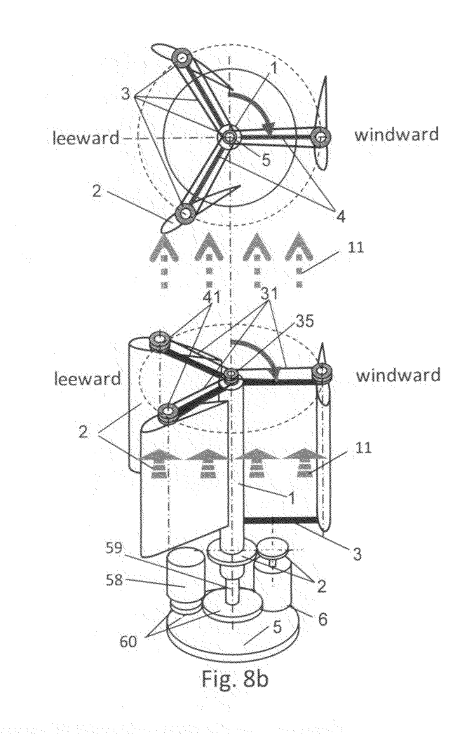

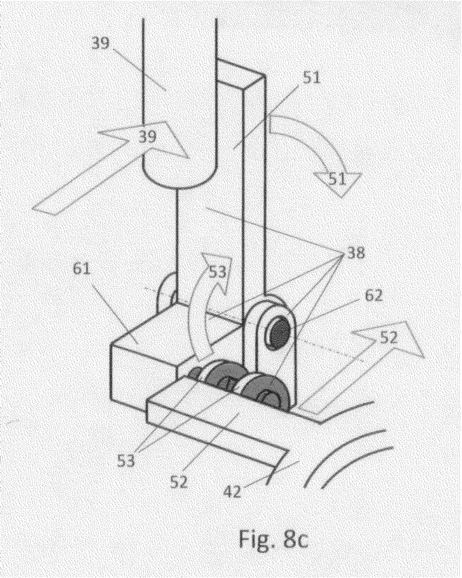

The second preferred embodiment, as shown in FIG. 8a, has the same main rotational shaft 1, airfoil blades 2, radial support arms 3, airfoil blade shaft 36, and airfoil blade shaft bearing 33 as the first preferred embodiment except the airfoil blade alignment mechanisms 4 are mechanically driven and controlled. Actually, inside the airfoil blade alignment mechanism, the torsional spring 37, airfoil blade cycler 42 with attached spring holder 44 and horizontal extension of airfoil blade cycler 52, and the one-way bearings 32 and 40 are also carried over from the first preferred embodiment. Additionally, an airfoil blade drive pulley/sprocket 41 replaces the airfoil blade drive gear 34 and a quick strike mechanism 38 replaces the solenoid 49 in the first preferred embodiment. A shaft pulley/sprocket 35, rigidly mounting to the stationary support structure 5, and timing belt/chain 31, connecting the shaft pulley/sprocket 35 and the airfoil blade drive pulley/sprocket 41, also replace the airfoil blade drive actuator 46 and airfoil blade drive gear 34 in the first preferred embodiment. A spring stop 43 is rigidly attached to the airfoil blade drive pulley/sprocket 41 to provide a stop for the torsional spring 37 just like in the first preferred embodiment. A striker 39 is rigidly installed to the airfoil blade drive pulley/sprocket 41 to interact with the quick strike mechanism 38.

The second preferred embodiment is also different from the first preferred embodiment in that it requires a turbine orientation mechanism to rotate the complete turbine relative to its stationary support structure 5 toward the fluid flow like a conventional cross-flow turbine. As shown in FIG. 8b, a turbine orientation actuator 58 receives signal from the electronic control module 48 with input signal from the fluid flow direction sensor 48 to turn a turbine shaft 59, which is rotationally installed to the stationary support structure 5, via a turbine orientation gearing 60. This operation ensures the blade orientation is aligned with the fluid flow direction. As for the first preferred embodiment, as shown in FIG. 5, this operation is performed by the airfoil blade drive actuators 46 with command from the electronic control module 48 to align the blades to the fluid flow direction.

FIG. 8c shows the interaction between the quick strike mechanism 38, striker 39, and airfoil blade cycler 42. The striker 39 turns with the airfoil blade drive pulley/sprocket 41, as shown in FIG. 8a. The spring stop 43, also rigidly installed to the airfoil blade drive pulley/sprocket 41, turns and compresses the torsional spring 37 when the airfoil blade drive pulley/sprocket 41 turns. The spring holder 44, which is rigidly attached to the airfoil blade cycler 42, remains in the same position because the horizontal extension of airfoil blade cycler 52, which is also rigidly connected to the airfoil blade cycler 42, is stopped by the airfoil blade cycler retainer 53, which is an integral part of the quick strike mechanism 38.

When the airfoil blade 2 reaches the windward position, as shown in FIG. 8a, the striker 39 touches the vertical extension of the horizontal extension of airfoil blade cycler 51 of the quick strike mechanism 38. The striker 39 then starts to push the vertical extension of quick strike mechanism 51 after the airfoil blade 2 passes the windward position, to effectively rotate the horizontal extension of quick strike mechanism 61 about the quick strike mechanism shaft When the horizontal extension of quick strike mechanism 61 rotates and lifts up enough, it clears the horizontal extension of airfoil blade cycler 52 so the airfoil blade cycler 42 starts to turn quickly, powered by the stored energy in the torsional spring 37. This rotates the airfoil blade 2 quick for 180° before the horizontal extension of airfoil blade cycler 61 is stopped by the airfoil blade cycler retainer 53 of the other quick strike mechanism 38 on the opposite side of the airfoil blade shaft 36.

The complete operation of the second preferred embodiment, as shown in FIG. 8a that is similar to the steps shown in FIGS. 7a to 7f, starts with the airfoil blade 2 reaching the windward position. The striker 39 touches and starts to push the vertical extension of quick strike mechanism 51 to turn, as shown in FIG. 8c. The airfoil blade cycler retainer 53 rotates and lifts up with the striker 39 keeping pushing the vertical extension of quick strike mechanism 51 further when the airfoil blade 2 moves pass the windward position. The horizontal extension of airfoil blade cycler 52, together with the airfoil blade cycle 42, is then cleared of contact with the airfoil blade cycler retainer 53 and free to move. The stored energy in the torsional spring 37 supplies energy to rotate the airfoil blade cycler 42 180° before the horizontal extension of airfoil blade cycler 52 is stopped by the airfoil blade cycler retainer 53 of the quick strike mechanism 38 on the opposite side of the airfoil blade shaft 36.

The airfoil blade 2 continues to rotate at half of the speed of the turbine's main rotational shaft 1 with the interaction between the Airfoil blade drive pulley/sprocket 41 and shaft pulley/sprocket 35 via the timing belt/chain 31. After the turbine turns 360°, the airfoil blade 2 turns 180° when it reaches the windward position again. The process as described above then repets—the airfoil blade 2 turns 180° quickly by the mechanical airfoil blade self-alignment mechanism 4.

I claim:

1. A turbine for generating mechanical power from fluid flow energy with a blade orientation alignment mechanism comprising:
a. A stationary support structure means rigidly installed to the ground or a stable foundation,
b. A main rotational shaft rotationally installed to said stationary support structure,
c. A plurality of radial support arms of equal length rigidly attached to said main rotational shaft on one ends and are spaced evenly between each other on the second ends,
d. A blade shaft installed rotationally attached to said second end of each of said blade shafts,
e. An airfoil blade rigidly attached to each of said blade shafts, and
f. Said blade orientation alignment mechanism further comprising a speed reduction actuation means, a turbine orientation control means with a fluid flow direction sensor, a quick rotate forward control means with an energy storage means and a quick release mechanism,
whereby said speed reduction actuation means rotates each of said airfoil blades around its said blade shaft at a constant speed of half of speed of said main rotational shaft, said turbine orientation control means with said fluid flow direction sensor senses fluid flow direction and turns said turbine so each of said airfoil blades feathers said fluid flow when said airfoil blade reaches the windward position with an attack angle of 180°, said energy storage means continuously extracts and stores mechanical energy from rotation of said main rotational shaft, said quick rotate forward control means starts to rotate said airfoil blade forward by 180° around said blade shaft when said airfoil blade reaches said windward position by activation of said quick release mechanism of said energy storage means and completes said 180° rotation before said airfoil blade rotates past said windward position by 10°, and said airfoil blade continues to rotate at said constant speed of half of speed of said main rotational shaft thereafter.

2. A turbine for generating mechanical power from fluid flow energy with a blade orientation alignment mechanism comprising:
a. A stationary support structure means rigidly installed to the ground or a stable foundation,
b. A main rotational shaft rotationally installed to said stationary support structure,
c. A plurality of radial support arms of equal length rigidly attached to said main rotational shaft on one ends and are spaced evenly between each other on the second ends,
d. A blade shaft installed rotationally attached to said second end of each of said blade shafts,
e. An airfoil blade rigidly attached to each of said blade shafts, and
f. Said blade orientation alignment mechanism further comprising an electric speed reduction actuation means, a turbine orientation control means with a fluid flow direction sensor, a quick rotate forward control means with an energy storage means and an electric quick release mechanism,
whereby said electric speed reduction actuation means rotates each of said airfoil blades around its said blade shaft at a constant speed of half of speed of said main rotational shaft, said turbine orientation control means with said fluid flow direction sensor senses fluid flow direction and turns said turbine so each of said airfoil blades feathers said fluid flow when said airfoil blade reaches the windward position with an attack angle of 180°, said energy storage means continuously extracts and stores mechanical energy from rotation of said main rotational shaft, said quick rotate forward control means starts to rotate said airfoil blade forward by 180° around said blade shaft when said airfoil blade reaches said windward position by activation of said electric quick release mechanism of said energy storage means and completes said 180° rotation before said airfoil blade rotates past said windward position by 10°, and said airfoil blade continues to rotate at said constant speed of half of speed of said main rotational shaft thereafter.

3. A turbine for generating mechanical power from fluid flow energy with a blade orientation alignment mechanism comprising:
a. A stationary support structure means rigidly installed to the ground or a stable foundation,
b. A main rotational shaft rotationally installed to said stationary support structure,
c. A plurality of radial support arms of equal length rigidly attached to said main rotational shaft on one ends and are spaced evenly between each other on the second ends,
d. A blade shaft installed rotationally attached to said second end of each of said blade shafts,
e. An airfoil blade rigidly attached to each of said blade shafts,
f. Said blade orientation alignment mechanism further comprising a mechanical speed reduction actuation means, a turbine orientation control means with a fluid flow direction sensor, a quick rotate forward control means with an energy storage means and a mechanical quick release mechanism,
whereby said mechanical speed reduction actuation means rotates each of said airfoil blades around its said blade shaft at a constant speed of half of speed of said main rotational shaft, said turbine orientation control means with said fluid flow direction sensor senses fluid flow direction and turns said turbine so each of said airfoil blades feathers said fluid flow when said airfoil blade reaches the windward position with an attack angle of 180°, said energy storage means continuously extracts and stores mechanical energy from rotation of said main rotational shaft, said quick rotate forward control means starts to rotate said airfoil blade forward by 180° around said blade shaft when said airfoil blade reaches said windward position by activation of said mechanical quick release mechanism of said energy storage means and completes said 180° rotation before said airfoil blade rotates past said windward position by 10°, and said airfoil blade continues to rotate at said constant speed of half of speed of said main rotational shaft thereafter.

4. Said turbine with a blade orientation alignment mechanism as recited in claim 2 wherein said electric speed reduction actuation means further comprising an electronic controller, a main shaft speed sensor, an electric motor, and a one-way rotational drive mechanism connects said electric motor to said blade shaft with a one-way clutch whereby said electronic controller receives signal of speed of said main rotational shaft from said main shaft speed sensor and controls said electric motor to turn said blade shaft at half of said speed of said main rotational shaft by said one-way rotational drive mechanism while said one-way clutch allows said electric motor to drive said blade shaft in one direction when said electric motor runs faster than said blade shaft and said blade shaft can freewheel said electric motor when said blade shaft runs faster than said electric motor in said one direction.

5. Said turbine with a blade orientation alignment mechanism as recited in claim 2 wherein said electric quick release mechanism further comprising a pair of solenoids installed 180° apart from each other with equal distance from the center of each of said blade shafts.

6. Said turbine with a blade orientation alignment mechanism as recited in claim 3 wherein said mechanical speed reduction actuation means further comprising a main shaft pulley installed rigidly to said main rotational shaft, a blade shaft pulley with a diameter twice of said main shaft pulley and rotationally installed to said blade shaft with a one-way clutch, and a matching belt connects said main shaft pulley to said blade shaft pulley whereby said blade shaft pulley turns said blade shaft at half of said speed of said main rotational shaft in one direction when said blade shaft pulley runs faster than said blade shaft while said blade shaft can freewheel when said blade shaft runs faster than said blade shaft pulley in said one direction.

7. Said turbine with a blade orientation alignment mechanism as recited in claim 3 wherein said mechanical speed reduction actuation means further comprising a main shaft sprocket installed rigidly to said main rotational shaft, a blade shaft sprocket having twice as many teeth as said main shaft sprocket and rotationally installed to said blade shaft with a one-way clutch, and a matching chain connects said main shaft sprocket to said blade shaft sprocket whereby said blade shaft sprocket turns said blade shaft at half of said speed of said main rotational shaft in one direction when said blade shaft sprocket runs faster than said blade shaft while said blade shaft can freewheel when said blade shaft runs faster than said blade shaft sprocket in said one direction.
